(19) United States
(12) Patent Application Publication
(10) Pub. No.: US 2004/0203525 A1
(43) Pub. Date: Oct. 14, 2004

(54) Electronic device having two-sided keypad and method of forming same

(75) Inventors: Joseph G. Gillette, Margate, FL (US); Scott Potter, Coconut Creek, FL (US); Sivakumar Muthuswamy, Plantation, FL (US); Steven D. Pratt, Plantation, FL (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(73) Assignee: Motorola, Inc.

(21) Appl. No.: 10/335,337

(22) Filed: Dec. 31, 2002

(51) Int. Cl. H04B 1/38

(52) U.S. Cl. 455/90.3; 455/550.1; 455/575.1

(57) ABSTRACT

A portable electronic device (100) includes a keypad (e.g. 300) that may be actuated from either side of a single substrate (301, 401, 501, 601, 701, 801). The keypad includes inner actuators (103) and outer actuators (205) that provide active contact, support and tactile feel from both sides of the substrate. The electronic device gains greater operability and utility since a single keypad is operable from either side of one housing.

### TECHNICAL FIELD

This invention relates in general to electronic keypads and more particularly to a portable electronic device having a two-sided keypad and method of forming same.

### BACKGROUND

The demand for portable electronic devices with the capability to access more information has led to unique form factors and non-conventional keypad display relationships. Many of today's small wireless products use some form of keypad in order to access and activate various functions of the device. One such device is a cellular telephone where a keypad is used not only to dial telephone numbers, but also to manipulate the many features incorporated within the device. Such features typically include application software driven features, such as calendars, email and/or games. A popular form factor of current cellular telephones is the “flip” or clamshell shape. These phones typically include two sections that fold upon one another. This allows the phone to remain small for portable use, yet still offers a great deal of functionality when opened. Typically, when extended in an open position, the top or upper section of the clamshell might include a liquid crystal display (LCD), while the lower section might include components such as a keypad having any number of buttons or keys. One drawback of the flip or clamshell arrangement is that one surface of the clamshell is typically the display while the other surface is typically a keypad. The keypad and the display take up the majority of surface area of the cellular phone preventing the use of a larger display or a greater number of buttons or keys for specialized features.

To overcome such a drawback, some cell phones, such as the i1000™ handset manufactured by Motorola, Inc. of Schaumburg, Ill., U.S.A., have included “pass through” keys or other arrangements that include a key and a plunger on the front surface of the closed clamshell cell phone to actuate keys beneath the surface without opening the phone. Unfortunately, pass through arrangements have limited use since only a certain number of pass through keys can be used, and not all keys of a keypad in the closed clamshell type cell phone can be accessed using pass through keys. Moreover, pass through keys do not operate when the clamshell cell phone is configured in its open position (i.e., with the flip or top section unfolded from the base or lower section). Other types of devices, such as some cellular telephones manufactured by Sony Ericsson Mobile Communications AB, use a keyboard that includes pass through keys to activate a touch screen underneath the upper portion of the cell phone. Such cell phones have the same limitations as do the cellular phones discussed above.

Thus, a need exists to provide a clamshell type wireless product that overcomes the deficiencies associated with pass through key arrangements.

### SUMMARY OF THE INVENTION

Briefly, according to the invention, an electronic device has a keypad with one or more actuators that are operable on both sides of the keypad. In one embodiment, tactile domes are used on both sides of a substrate such that the tactile domes may be flexed in order to provide an electrical connection to conductive pads. The flexible domes enable a keypad to be formed using a single substrate where functionality of the electrical device can be maintained from either side of the substrate. In yet another embodiment, a tactile dome on one side of a substrate may actuate a conductive pad on the same side of the substrate either through movement of the tactile dome or movement of the substrate.

### BRIEF DESCRIPTION OF THE DRAWINGS

The features of the present invention, which are believed to be novel, are set forth particularly in the appended claims. The present invention, together with further objects and advantages thereof, may best be understood by reference to the following description, taken in conjunction with the accompanying drawings, in several figures of which reference numerals identify like elements, and in which:

FIG. 1 illustrates a top view of a cellular telephone having a clamshell type housing in an open position where a keypad can be used on both sides of the upper housing according to a preferred embodiment of the present invention;

FIG. 2 illustrates the cellular telephone as shown in FIG. 1 where the clamshell type housing is in a closed position showing a keypad on the opposite side of the upper housing;

FIG. 3 illustrates a side view of a double-sided keypad using two tactile domes on either side of a printed circuit board according to a preferred embodiment of the present invention;

FIG. 4 illustrates a side view of a double-sided keypad using a single tactile dome on one side of a printed circuit board according to an alternative embodiment of the present invention;

FIG. 5 illustrates a side view of a double-sided keypad using two carbon pills on either side of a printed circuit board according to yet another alternative embodiment of the present invention;

FIG. 6 illustrates a side view of a double-sided keypad using a single carbon pad on one side of a printed circuit board according to yet another alternative embodiment of the present invention;

FIG. 7 illustrates a side view of a double-sided keypad using a single tactile dome on one side of a flexible circuit according to yet another embodiment of the present invention;

FIG. 8 illustrates a side view of a double sided keypad having a single tactile dome on one side of a flexible circuit where a key button includes end stops according to yet another embodiment of the present invention; and

FIG. 9 illustrates a top view of a flexible circuit having cutouts to enhance the feel of the push-button motion on the keypad according to one embodiment of the present invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

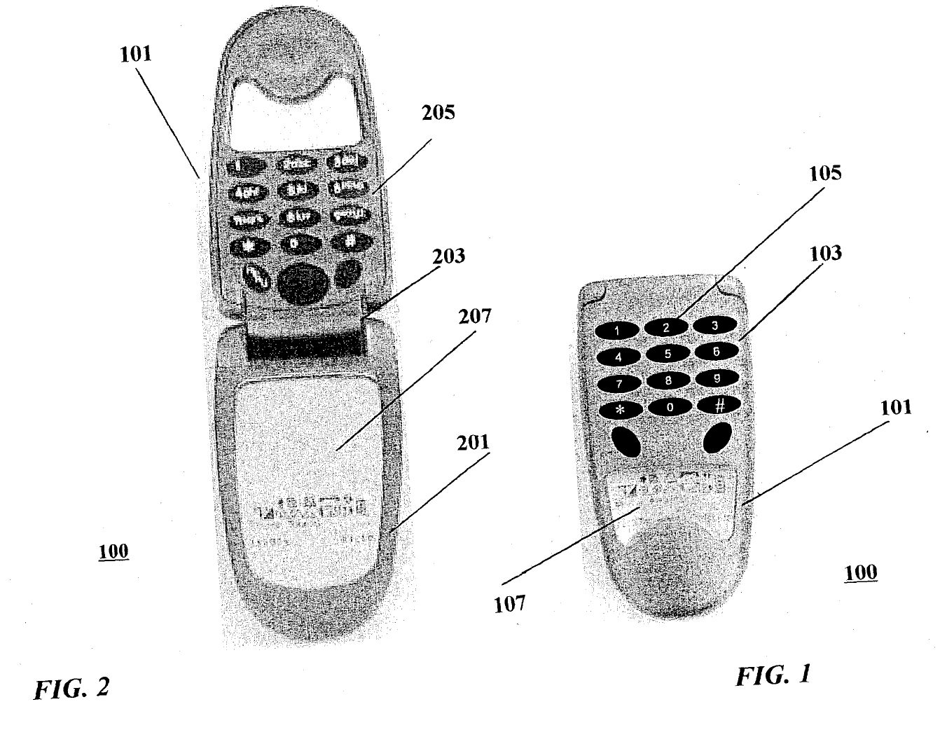

Referring now to FIG. 1, an electronic device 100, such as a cellular telephone, is illustrated having a clamshell type form factor. The upper housing of the clam, also known as “the flip” 101, is shown in a closed position so as to expose an external keypad and display 107, and conceal an internal keypad and display. The external keypad includes outer actuators 103 that are positioned on the outer surface of the flip 101. The outer actuators 103 preferably include key buttons 105 that are used in various combinations by the user to control functionality of the electronic device 100. Thus, various functions of the device 100 can be controlled while viewing the outer display 107, which may be located on the lower portion of the flip 101. This configuration offers an advantage in that the device 100 may remain in a closed position, while the device 100 maintains a great degree of functionality through the use of the outer actuators 103 and outer display 105.

As seen in FIG. 2, should the user desire even a greater degree of functionality or wish to operate the device 100 having a certain degree of privacy like a telephone, the device 100 may be unfolded into an open position. To open the device 100, the flip 101 is rotated about a pivot or hinge 203 in order to unfold the upper housing portion 101 from the lower housing portion 210, as would a clamshell. When in the open position, inner actuators 205 allow the user to operate various aspects of the device 100 from inside the device 100 while viewing an inner display 207. The inner actuators 205, like their outer counterparts, preferably comprise key buttons. The inner display 207 might be located on the lower portion 201 of the device 100.

This type of configuration offers the user distinct advantages in that a larger display can be used in the lower housing 201, which in other configurations might need to be shared with a keypad. The larger inner display 207 has many advantages over a smaller display. Not only can greater amounts of information be conveyed to the user, but the information might also be displayed in various formats that are much easier for the user to read and/or interpret. Additionally, the device 100 will be able to detect the operational position of the housing through use of a position sensor, such as a Hall effect sensor or other device that can detect orientation and/or position. By knowing its operational position, the electronic device 100 can adjust the functionality of the inner key buttons 205, the outer key buttons 105, the outer display 107, and the inner display 207 based on such operation position. As will be recognized by those skilled in the art, a microprocessor (not shown) within the device 100 may operate to enable or disable various device functionality such as key buttons and/or display, based upon the operational position of the device 100.

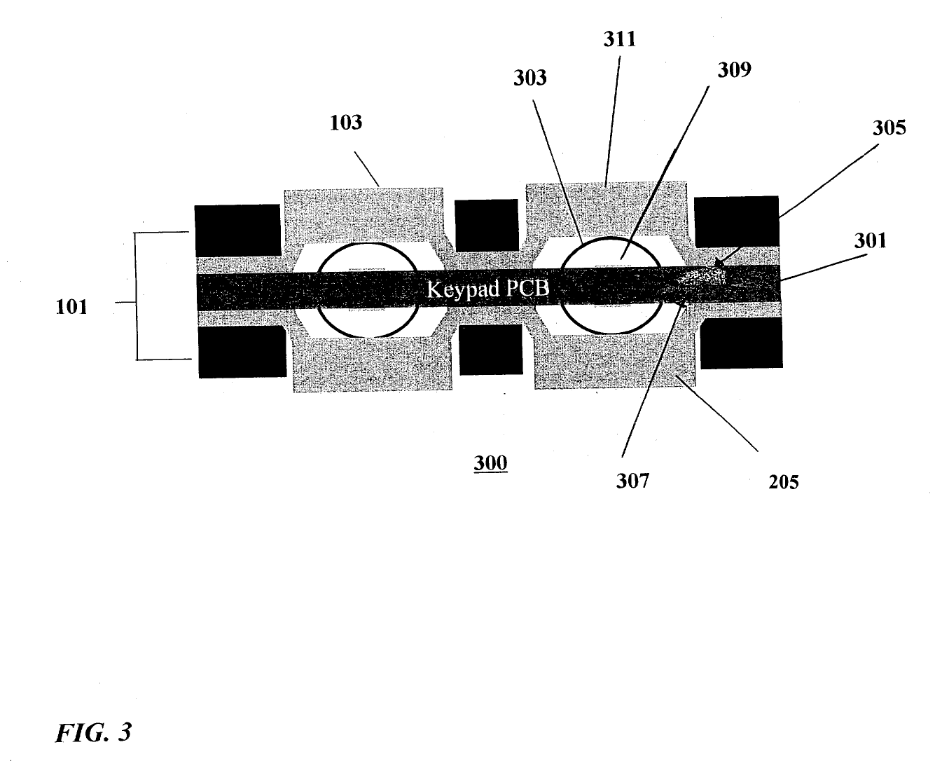

According to a preferred embodiment of the invention, FIG. 3 illustrates one configuration where the outer actuators 103 and the inner actuators 205 can be positioned symmetrically on the upper portion 101 of the device 100 to effectively form a single keypad 300 that is operable from-both sides of the upper or flip portion 101. That is, keypad 300 functions as both the internal keypad and the external keypad of the electronic device 100. Both sets of actuators 103, 205 are preferably thin to allow the flip 101 to retain a slim profile with little added weight. The keypad 300 includes a single substrate 301 that extends in some predetermined form factor capable of fitting within the flip 101. One or more tactile domes 303 are positioned on both the upper surface 305 and lower surface 307 of the substrate 301. Substrate 301 may be made of any printed circuit board material, such as polyimide, cyanate ester, or FR-4 having etched copper traces and pads.

The tactile dome 303 is a conductive dome typically having a convex shape. The tactile dome 303 is made of a flexible, conductive material, such as aluminum, that can bridge a connection between two or more conductive targets or pads 305, 309. When flexed into positioned, the tactile dome 303 establishes an electrical connection between two or more of the pads 305, 309 enabling an electrical circuit to be established. In order to enable a user to flex the tactile dome 303 to establish such an electrical connection, a key button 311 is used to facilitate movement of the tactile dome 303. The key button 311 is preferably manufactured of a pliable material, such as silicone rubber, enabling the key button 311 to ride upon an outer surface of the tactile dome 303. When a force is provided by the user to the key button 311, the key button 311 contacts the outer surface of the tactile dome 303 enabling the tactile dome 303 to flex from its convex shape and establish a connection between conductive pads 305, 309. As will be evident to those skilled in the art, the tactile dome configuration illustrated in FIG. 3 operates on both sides of the substrate 301 enabling both inner actuators 103 and outer actuators 205 to operate from respective sides of the flip 101.

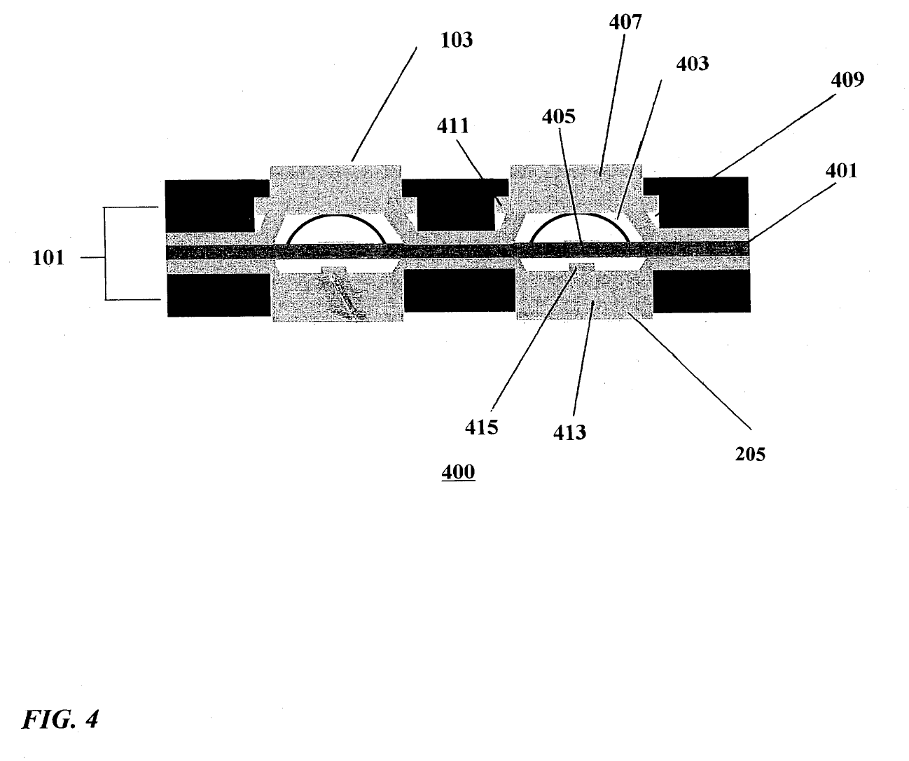

In an alternative embodiment, FIG. 4 illustrates a keypad 400 that can be actuated on both sides of a substrate 401 with tactile domes 403 positioned on only one side of the substrate 401. In this embodiment, a substantially thin substrate 401 is used that can flex approximately one-half millimeter. Similar to the above description with respect to FIG. 3, a tactile dome 403 is positioned on one side of the substrate 401 and flexes to provide an electrical connection between two or more conductive pads 405. An outer key button 407 enables the user to flex the tactile dome 403 into a position where it can make electrical contact. Unlike the embodiment shown in FIG. 3, the outer key button 407 is positioned within a channel 409. A stop 411 is used with the outer key button 407 enabling the key button 407 to move only a predetermined distance within the channel 409. Thus, as seen in FIG. 4, when the key button 407 remains unactuated, it will remain a fixed, predetermined distance from the substrate 401.

When using the inner actuator 205, the inner key button 413 includes an indenter 415. When a force is applied to the inner key button 413, the indenter 415 contacts the surface of the substrate 401. Since the substrate 401 is substantially thin and able to flex, the substrate 401 flexes to a position where the conductive pads 405 move toward the tactile dome 403. In view of the fixed position of the outer key button 407, the tactile dome 403 cannot move away from the substrate 401. Thus, the fixed positioning of the outer key button 407 and the flexibility of the substrate 401 allow the conductive pads 405 to make electrical contact with the tactile dome 403 to establish an electrical connection.

Those skilled in the art will recognize that the embodiments illustrated in FIGS. 3 and 4 enable formation of a keypad with actuators on one or both sides of a substrate to establish an electrical connection using one or more tactile domes. Although FIG. 4 illustrates one or more tactile domes 403 on only one side of the substrate 401 (i.e. the side associated with the outside actuators 103), it should be evident that this embodiment would also be enabled with one or more tactile domes positioned on the other side of the substrate 401 (i.e., the side associated with the inside actuators 205). In the latter case, the indenters 415 would be used on the outside actuator side of the substrate 401.

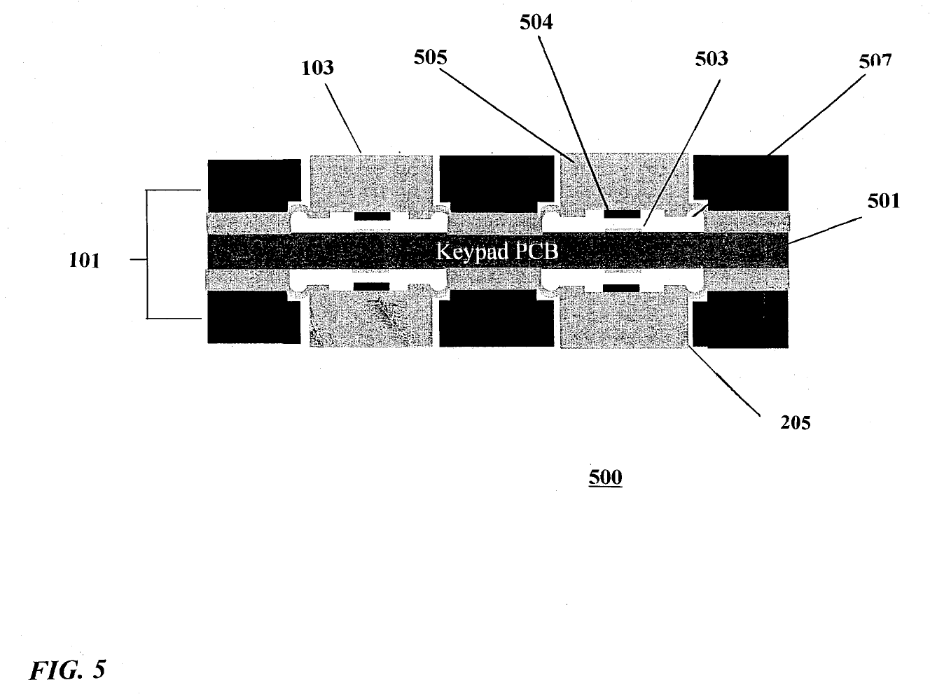

FIG. 5 illustrates still yet another embodiment of the present invention similar to the embodiment of FIG. 3, except that no tactile domes are used. In this embodiment, a keypad 500 includes a substrate 501 having one or more conductive targets or pads 503. The conductive pad 503 includes one or more conductive segments to enable an electrical connection to be established between two points on the pad. The electrical connection is established through the use of a carbon pill or pad 504 or the like attached to an inside surface of each key button 505. Each key button 505 includes a flex member 507 that enables the key button 505 to have resilience against lateral force applied to the key button 505. In this way, the key button 505 will return to a starting position without the use of a spring or tactile dome positioned beneath the key button assembly. Similar to the embodiment shown in FIG. 3, a key button 505 (which may be key button 103 or 205, as applicable) is positioned on both sides of the substrate 501. When force is applied to the key button 505, the key button 505 moves to a position where it contacts the conductive pad 503 enabling an electrical connection to be made.

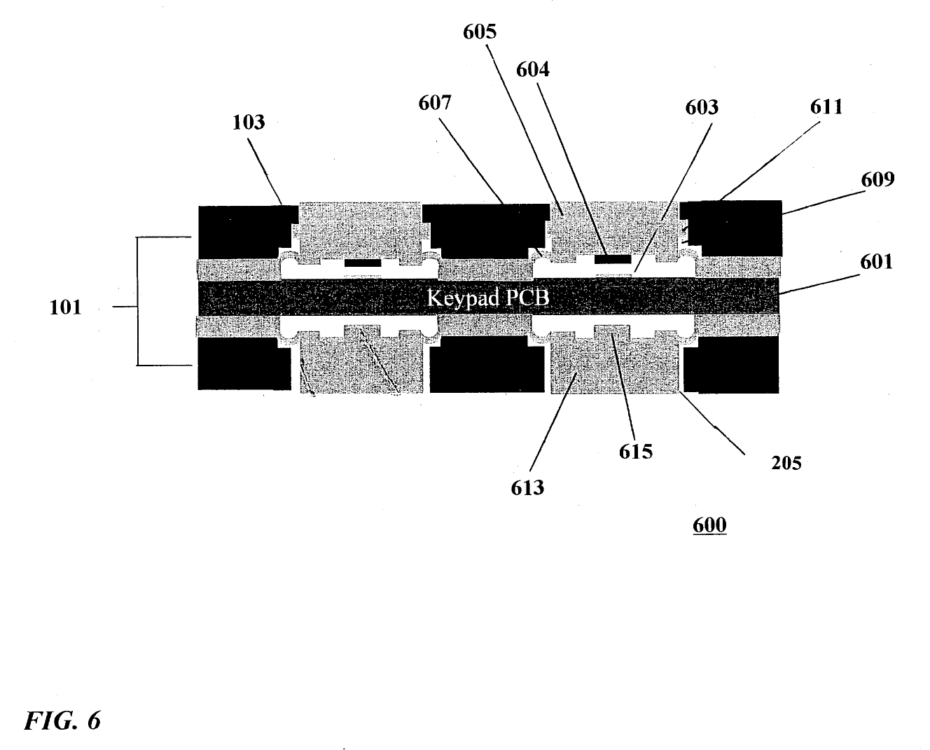

FIG. 6 illustrates still yet another embodiment of the present invention similar to the embodiment shown in FIG. 4. In this embodiment, a keypad 600 includes one or more conductive targets or pads 603 positioned on a flexible substrate 601. As with the embodiment of FIG. 4, the conductive pad 603 enables an electrical connection to be established between two conductive points on the pad 603. A carbon pill 604 or the like is positioned below and is adhesively attached to a key button 605 that bridges the connection between segments on the conductive pad 603. Like the embodiment shown in FIG. 5, the key button 605 includes a flex member 607 providing resilience and a tactile feel when a lateral force is applied to the key button 605. Like the embodiment of FIG. 4, the key button 605 moves within a channel 609 and uses a stop 611, such that the key button 605 will remain a fixed distance from the substrate 601 when in an unactuated position. On the opposite side of the substrate 601, each key button 613 includes an indenter 615. When force is applied to a key button 613 (e.g., a key button 205 on the inside surface of the flip 101), the indenter 615 contacts and flexes the substrate 601 into a position where a contact pad 603 can make electrical contact with the carbon pill 604. As will be recognized by those skilled in the art, this embodiment provides the use of carbon pills or pads 604 on only one side of the substrate 601.

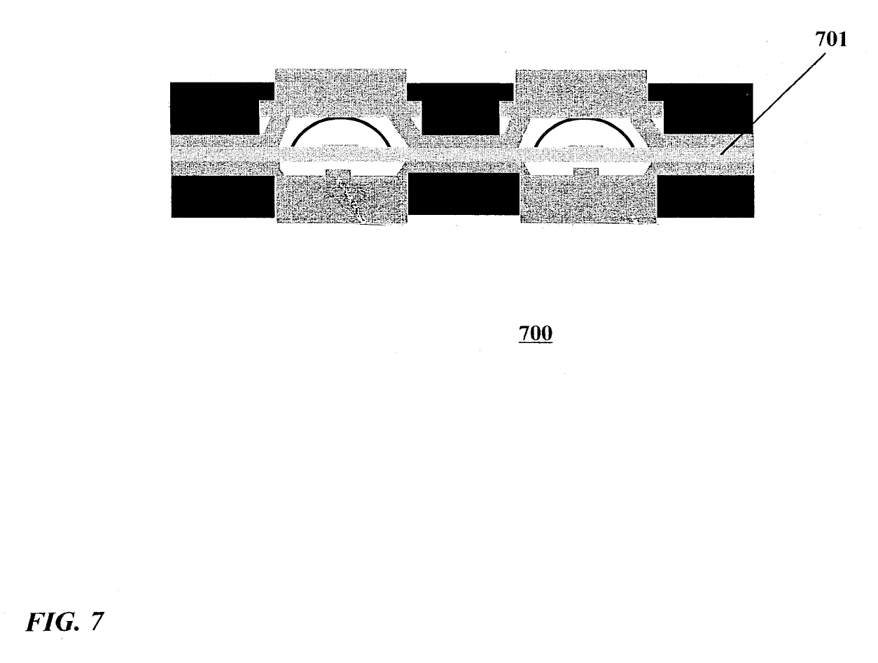

FIG. 7 illustrates yet another embodiment of the present invention similar to the embodiment shown in FIG. 4. In this embodiment, a keypad 700 includes the use of a flexible circuit 701. As known by those skilled in the art, the flexible circuit is an extremely pliable material enabling it to flex and bend to a much greater degree than a flexible printed circuit board. Operationally, the keypad 700 operates like the keypad 400 shown in FIG. 4; however, the flexible circuit 701 is much more resilient enabling it to have many more operational cycles without failure.

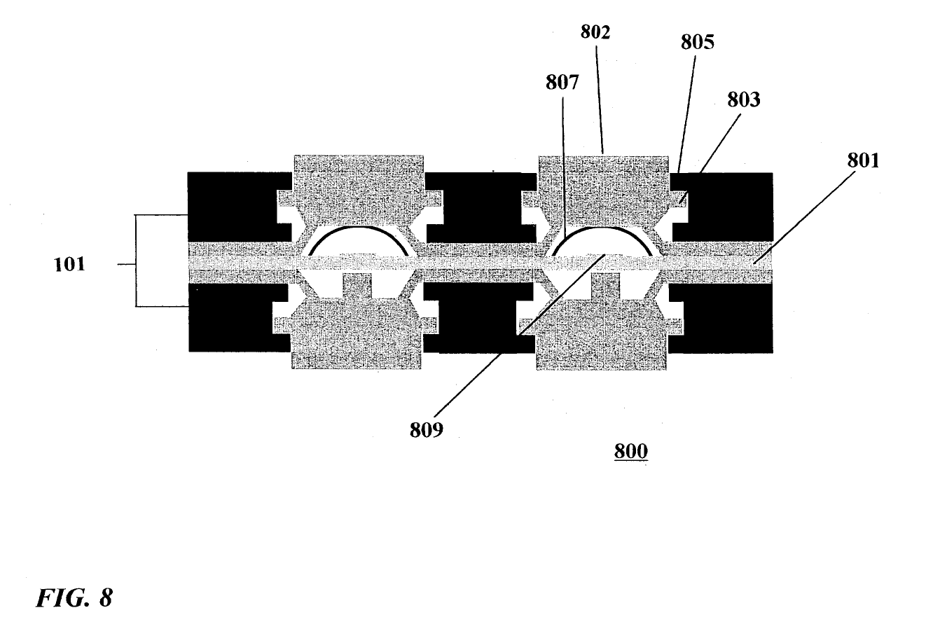

FIG. 8 illustrates yet another embodiment of the present invention similar to the embodiment shown in FIG. 7. In this embodiment, a keypad 800 uses a flexible circuit 801; however, key buttons 802 are used on both sides of the flexible circuit 801. Each key button 802 includes a first stop 803 that rests upon a second stop 805 that is integrated into the flip 101. Although operationally similar to the embodiments illustrated in both FIG. 4 and FIG. 7, the keypad 800 and the key buttons 802 have better travel control. Such travel control insures that when a key button 802 is pushed from the inner side of the flip 101, the tactile dome 807 has a firm surface upon which to flex and make electrical contact with the pads 809.

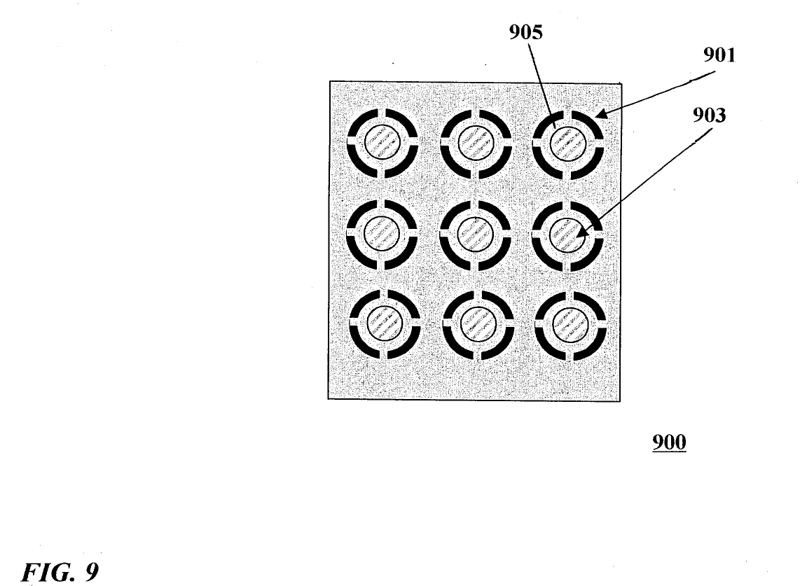

FIG. 9 illustrates a top view of a flexible circuit 900 having cutouts 901 to enhance the tactile feel of the push-button motion on the keypad. When a carbon pill or other conductive member (not shown) is forced into the conductive pad area 905, two or more target areas or traces may be electrically connected to establish an electrical connection. The cutouts 901 allow the circular area 905 located about the conductive pad 903 to move and flex providing resilience to a key button (not shown) used in connection with that pad 903.

Thus, the present invention provides an apparatus and method by which a keypad can become operable from both sides of a substrate used to form the keypad. Through the use of tactile domes and/or carbon pills the keypad can operate to establish one or more electrical connections on either side of the substrate. This enables a single keypad to be used from both sides of a unitary housing. Electronic products having a clamshell type configuration can gain great advantage through use of the present invention because the products will have greater utility while gaining more usable space for other components, such as a larger display, with little increase in weight.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A portable electronic device comprising:
a first housing portion;
a second housing portion pivotally connected to the first housing portion; and
a keypad operable from both sides of the first portion.

2. A portable electronic device as in claim 1, further comprising:
at least one display operable with the keypad.

3. A portable electronic device as in claim 1, wherein the keypad comprises:
a substrate;
a first actuator for triggering an electrical contact on a first side of the substrate; and
a second actuator positioned for triggering an electrical contact on an opposite side of the substrate;
wherein the first actuator and the second actuator are independently operable to control a single function.

4. A portable electronic device having a keypad operable from both sides of a single substrate comprising:
a first actuator for triggering an electrical contact on a first side of the substrate;
a second actuator positioned for triggering an electrical contact on an opposite side of the substrate; and
wherein the first actuator and the second actuator are independently operable to control a single function on the keypad of the portable electronic device.

5. A portable electronic device as in claim 4, wherein the first actuator and the second actuator are for use with respective operational positions of the portable electronic device.

6. A portable electronic device as in claim 4, further comprising a tactile dome, wherein the first actuator mechanically contacts the tactile dome.

7. A portable electronic device as in claim 6, wherein the tactical dome flexes to trigger the electrical contact.

8. A portable electronic device as in claim 6, wherein the first actuator further includes a key button for contacting the tactile dome, and wherein the key button travels in a channel having an end stop for providing limited movement of the key button.

9. A portable electronic device as in claim 4, further comprising a carbon pad attached to the first actuator.

10. A portable electronic device as in claim 9, wherein the first actuator is deformable to allow the carbon pad to trigger the electrical contact.

11. A portable electronic device as in claim 9, wherein the first actuator includes a key button and wherein the key button travels in a channel having an end stop for providing limited movement of the key button.

12. A portable electronic device as in claim 4, further comprising a tactile dome, wherein the second actuator mechanically contacts the tactile dome.

13. A portable electronic device as in claim 12, wherein the second actuator includes a key button for contacting the tactile dome, and wherein the key button travels in a channel having an end stop for providing limited movement of the key button.

14. A portable electronic device as in claim 4, further comprising a carbon pad attached to the second actuator.

15. A portable electronic device as in claim 4, wherein the substrate is a printed circuit board (PCB).

16. A portable electronic device as in claim 4, wherein the substrate is a flexible circuit.

17. A method for actuating a keypad operable from both sides of a housing in a portable electronic device comprising:
providing a single substrate within the housing;
positioning the at least one conductive pad on at least one side of the single substrate;
positioning a conductive member upon the at least one conductive pad so as to establish an electrical connection; and
actuating the at least one conductive pad with the conductive member from either side of the single substrate.

18. A method for actuating a keypad as in claim 17, further including:
flexing the single substrate to facilitate contact between the conductive member and the at least one conductive pad.

19. A method for actuating a keypad as in claim 17, further including:
establishing electrical contact between the conductive member and the at least one conductive pad on a first side of the single substrate using an actuator located on the first side of the single substrate.

20. A method for actuating a keypad as in claim 19, wherein the actuator controls movement of the conductive member.

21. A method for actuating a keypad as in claim 19, wherein the actuator includes a carbon pill that contacts the conductive member to actuate the at least one conductive pad.

22. A method for actuating a keypad as in claim 17, further including:
establishing electrical contact between the conductive member and the at least one conductive pad on a first side of the single substrate using an actuator located on a second side of the single substrate.

23. A method for actuating a keypad as in claim 17, wherein the conductive member is a tactile dome.
